(19) United States
(12) Patent Application Publication
(10) Pub. No.: US 2022/0138749 A1
(43) Pub. Date: May 5, 2022

(54) METHOD AND SYSTEM FOR SECURED AND STABLE BLOCKCHAIN TRANSACTION BY OBTAINING PRE-APPROVAL OF BOTH PARTIES

(71) Applicant: HON HAI PRECISION INDUSTRY CO., LTD., New Taipei (TW)

(72) Inventor: CHIEN-FU LIN, New Taipei (TW)

(21) Appl. No.: 17/512,883

(22) Filed: Oct. 28, 2021

(30) Foreign Application Priority Data
Oct. 30, 2020 (CN) 202011193310.1

(51) Int. Cl. G06Q 20/40; G06Q 20/06; G06Q 20/38

(52) U.S. Cl. CPC G06Q 20/401; G06Q 2220/00; G06Q 20/3825; G06Q 20/065

(57) ABSTRACT

A method for transaction initiator and recipient to both pre-approve the form and content of a blockchain transaction generates a transaction request by the initiator, and transmits the transaction request to the transaction recipient for verification of the content of the transaction request. The method also signs a digital signature of the transaction recipient on the transaction request if the verification is passed. And a transfer of funds into an account of the transaction recipient can then be made from an account of the transaction initiator. A related system is also disclosed.

### FIELD

The subject matter herein generally relates to blockchaining and particularly, to a method and a system for blockchain transaction.

### BACKGROUND

In a blockchain transaction, transaction initiator can complete a transaction with only an address of the transaction recipient, and the transaction recipient does not need to take part in the transaction. Thus, the transaction recipient may encounter malicious attacks, such as a dusting attack, and so on, and the transaction initiator and the transaction recipient may not accept that the execution of the transaction has been completed.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an embodiment of a secure system for a blockchain transaction.

FIG. 2 illustrates a view showing connections for communication among a transaction initiator terminal, a transaction recipient terminal, and a blockchain node.

FIG. 3 illustrates a flowchart of an embodiment of a method for securing a blockchain transaction.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

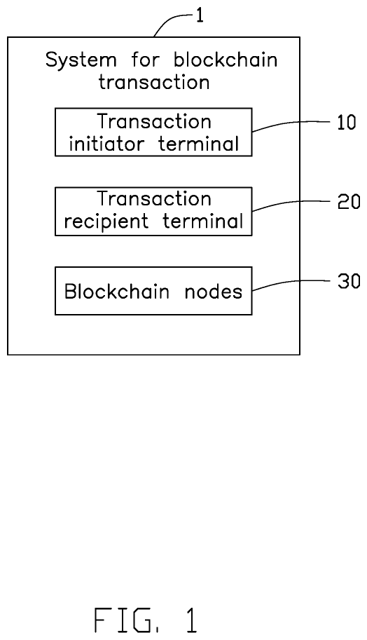

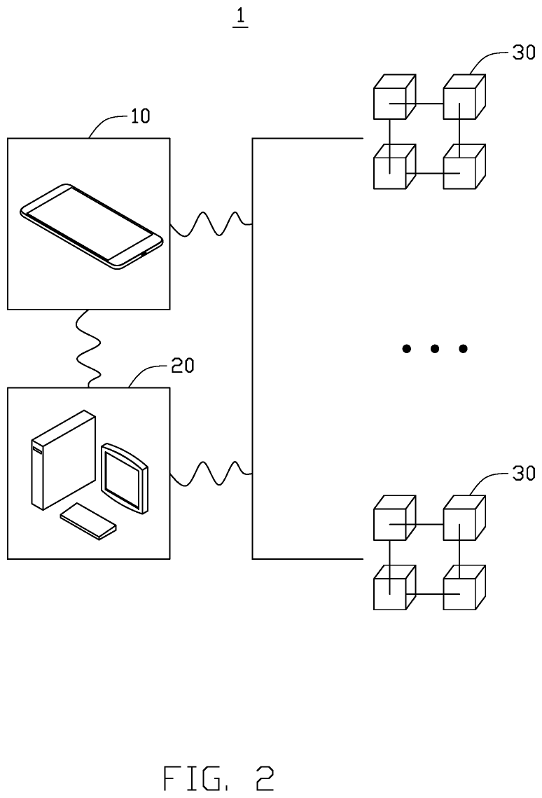

Referring to FIGS. 1-2, a system for blockchain transaction 1 includes a transaction initiator terminal 10, a transaction recipient terminal 20, and blockchain nodes 30. The transaction initiator terminal 10 and the transaction recipient terminal 20 can each be an electronic device, for example, a smart phone, a tablet computer, a portable computer, or the like. The transaction initiator terminal 10, the transaction recipient terminal 20, and the blockchain nodes 30 can communicate with each other. In the embodiment, the transaction initiator terminal 10, the transaction recipient terminal 20, and the blockchain nodes 30 communicate with each other via a wire or wirelessly.

The transaction initiator terminal 10 is configured to generate a transaction request. The transaction request includes a sign of a transaction initiator, a sign of a transaction recipient, transaction amount, transaction time, and a digital signature of the transaction initiator. The transaction initiator terminal 10 is further configured to transmit the transaction request to the transaction recipient. The transaction recipient terminal 20 is configured to verify the transaction request. The transaction recipient terminal 20 is further configured to sign a digital signature of the transaction recipient on the transaction request if the verification is passed. The transaction initiator terminal 10 is further configured to transfer funds into an account of the transaction recipient from an account of the transaction initiator.

In the embodiment, the transaction initiator terminal 10, the transaction recipient terminal 20, and the blockchain nodes 30 each represent and include a client. The transaction initiator terminal 10, the transaction recipient terminal 20, and the blockchain nodes 30 each can access the blockchain via the client, to operate the blockchain application.

In the embodiment, the sign of the transaction initiator is a unique identity representing the transaction initiator, for example, a client sign, a public key, or the like. The sign of the transaction initiator uniquely identifies the transaction initiator. The sign of the transaction recipient is a unique identity representing the transaction recipient, for example, a client sign, a public key, or the like. The sign of the transaction recipient uniquely identifies the transaction recipient. The transaction time includes a time of initiating the transaction. The digital signature of the transaction initiator is configured to verify the identity of the transaction initiator. In the embodiment, the transaction request is not limited to only include the aforementioned sign of the transaction initiator, the aforementioned sign of the transaction recipient, the aforementioned transaction amount, the aforementioned transaction time, and the aforementioned digital signature of the transaction initiator. The transaction request may also include other information, for example, a sequence number of the request, a time limit, a security code, a note, a verification code, and so on. The sequence number of the request is a unique identity of the transaction. Different sequence numbers of the request represent different transactions. The time limit limits a time period for completing and finishing the transaction. Together with the digital signature of the transaction initiator, the security code is configured to verify the identity of the transaction initiator, providing a double authentication function. The note contains a summary of transaction details, or the like. The note assists the transaction recipient to understand the transaction. The verification code is a one-time password. The verification code verifies the transaction initiator as being an authorized user in the blockchain.

In the embodiment, the transaction initiator terminal 10 can receive via the client an input as to the content of the transaction, and generate the transaction request according to the transaction content and a specification as to format of the transaction request. In the embodiment, the format specification of the transaction request specifies content which is needed by the transaction record. For example, the format specification of the transaction request includes the sign of the transaction initiator, the sign of the transaction recipient, and the transaction amount. Thus, the transaction content must include the sign of the transaction initiator, the sign of the transaction recipient, and the transaction amount. The transaction initiator terminal 10 can transmit the transaction request to the transaction recipient terminal 20 via the client.

In the embodiment, the transaction recipient terminal 20 can verify the transaction request automatically, namely executing an automatic verification. The transaction recipient terminal 20 can also manually verify the transaction request, namely executing a manually verification. The automatic verification can include the transaction recipient terminal 20 decrypting the transaction request via the client, and verifying the digital signature of the transaction initiator, verifying that the format of the transaction request meets with the format specification, and verifying that the transaction initiator does have asset ownership of the transaction amount. The manual verification can include the transaction recipient terminal 20 displaying the content of the transaction request via the client for the transaction recipient to verify correctness of the transaction request. In the embodiment, the transaction recipient terminal 20 further provides an authentication pass option and an authentication fail option via the client, allowing the transaction recipient to determine whether the content of the transaction request is right or wrong. In the embodiment, if the automatic verification fails, the transaction recipient terminal 20 provides the authentication fail option via the client for the transaction recipient to select. Alternatively, there can be an automatic determination that the verification is failed. Obviously, if the authentication pass option is selected, the transaction recipient terminal 20 determines that the verification is passed. If the authentication fail option is selected, the transaction recipient terminal 20 determines that the verification is failed. In the embodiment, if the verification is failed, the transaction does not proceed and is ended.

In the embodiment, the transaction recipient terminal 20 is further configured to transmit the transaction request including the digital signature of the transaction initiator and the digital signature of the transaction recipient to the blockchain nodes 30 before transferring the funds into the account of the transaction recipient from the account of the transaction initiator. The blockchain nodes 30 also verify the digital signature of the transaction initiator and the digital signature of the transaction recipient. In the embodiment, not less than two blockchain nodes 30 are employed. The transaction initiator terminal 10 is further configured to transfer the funds into the account of the transaction recipient from the account of the transaction initiator if the verification of the digital signature of the transaction initiator and the digital signature of the transaction recipient is passed.

In the embodiment, the blockchain nodes 30 also verify the digital signature of the transaction initiator, the digital signature of the transaction recipient, and the format of the transaction request. The transaction initiator terminal 10 is further configured to transfer the funds into the account of the transaction recipient from the account of the transaction initiator if the verification of the digital signature of the transaction initiator, the digital signature of the transaction recipient, and the format of the transaction request is passed.

In the embodiment, the blockchain nodes 30 initiate a consensus processing on the transfer of funds. The blockchain nodes 30 are further configured to record to the blockchain the transfer of funds if the consensus is reached.

In the embodiment, the transaction recipient terminal 20 is further configured to draw up transaction information in advance before the transaction initiator terminal 10 generates the transaction request. The transaction information includes the sign of the transaction initiator, the sign of the transaction recipient, the transaction amount, and the time of the transaction. The transaction recipient terminal 20 is further configured to transfer the transaction information to the transaction initiator. The transaction initiator terminal 10 is further configured to generate the transaction request according to the transaction information. In the embodiment, the transaction information is not limited to only include the aforementioned content, but may also include other content, for example, a sequence number of the request, a time limit, a security code, a note, a verification code, and so on. The transaction recipient terminal 20 is further configured to transfer the transaction information to the transaction initiator terminal 10 via the client. Thus, before executing the transfer of funds, the transaction initiator and the transaction recipient can review the content of the transaction. Thus, errors in included content can be avoided in advance, which prevents a benefit of the transaction initiator from being damaged.

In the disclosure, the transaction request includes the digital signature of the transaction initiator, the transaction recipient verifies the transaction request, and signs the digital signature of the transaction recipient on the transaction request if the verification is passed. This avoids the transaction recipient encountering malicious attacks, for example dusting attack, and so on, and also avoids non-acceptance by either the transaction initiator or the transaction recipient of execution of the transaction. The disclosure also provides the drawing up of the transaction information in advance, before the transaction request is generated, and allows the transaction information to be presented in advance to the transaction initiator. The transaction initiator and the transaction recipient can both review the content of the transaction in advance before executing the funds transfer, avoiding the inclusion of errors in the proposed transaction, which prevents a benefit of the transaction initiator from being damaged.

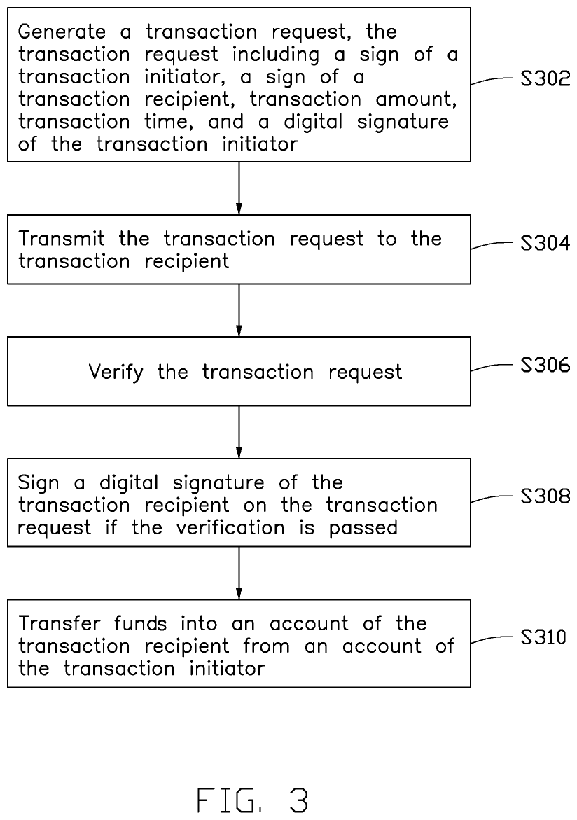

FIG. 3 illustrates a flowchart of an embodiment of a method for blockchain transaction. The method begins at block S302.

At block S302, generating a transaction request, the transaction request including a sign of a transaction initiator, a sign of a transaction recipient, transaction amount, transaction time, and a digital signature of the transaction initiator.

At block S304, transmitting the transaction request to the transaction recipient.

At block S306, verifying the transaction request.

At block S308, signing a digital signature of the transaction recipient on the transaction request if the verification is passed.

At block S310, transferring funds into an account of the transaction recipient from an account of the transaction initiator.

In the embodiment, before generating the transaction request, the method further includes a step a1 and a step a2. The step a1 includes drawing up transaction information in advance. The transaction information includes the sign of the transaction initiator, the sign of the transaction recipient, the transaction amount, and the time of the transaction. The step a2 includes transferring the transaction information to the transaction initiator. The generating the transaction request includes generating the transaction request according to the transaction information.

In the embodiment, the method further includes ending the transaction if the verification is failed.

In the embodiment, before transferring the funds into the account of the transaction recipient from the account of the transaction initiator, the method further includes a step b1 and a step b2. The step b1 includes transmitting the transaction request including the digital signature of the transaction initiator and the digital signature of the transaction recipient to the blockchain nodes. The step b2 includes verifying the digital signature of the transaction initiator and the digital signature of the transaction recipient. The transferring funds into an account of the transaction recipient from an account of the transaction initiator includes a step c1. The step c1 includes transferring the funds into the account of the transaction recipient from the account of the transaction initiator if the verification of the digital signature of the transaction initiator and the digital signature of the transaction recipient is passed.

In the embodiment, the method further includes a step d1 and a step d2. The step d1 includes initiating a consensus processing on the transfer of funds. The step d2 includes recording to the blockchain the transfer of funds if the consensus is reached.

The method can vary to another embodiments, the varied embodiments of the method are the same as the varied embodiments of the system, which are not described herein.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for blockchain transaction comprising:
generating a transaction request, the transaction request comprising a sign of a transaction initiator, a sign of a transaction recipient, transaction amount, transaction time, and a digital signature of the transaction initiator;
transmitting the transaction request to the transaction recipient;
verifying the transaction request;
signing a digital signature of the transaction recipient on the transaction request if the verification is passed;
transferring funds into an account of the transaction recipient from an account of the transaction initiator.

2. The method according to claim 1, wherein:
before generating the transaction request, the method further comprises:
drawing up transaction information in advance, the transaction information comprising the sign of the transaction initiator, the sign of the transaction recipient, the transaction amount, and the transaction time;
transferring the transaction information to the transaction initiator;
the generating the transaction request comprises:
generating the transaction request according to the transaction information.

3. The method according to claim 1, wherein the method further comprises:
ending the transaction if the verification is failed.

4. The method according to claim 1, wherein:
before transferring funds into an account of the transaction recipient from an account of the transaction initiator, the method further comprises:
transmitting the transaction request comprising the digital signature of the transaction initiator and the digital signature of the transaction recipient to the blockchain nodes;
verifying the digital signature of the transaction initiator and the digital signature of the transaction recipient;
the transferring funds into an account of the transaction recipient from an account of the transaction initiator comprises:
transferring the funds into the account of the transaction recipient from the account of the transaction initiator if the verification of the digital signature of the transaction initiator and the digital signature of the transaction recipient is passed.

5. The method according to claim 4, wherein:
the verifying the digital signature of the transaction initiator and the digital signature of the transaction recipient comprises:
verifying the digital signature of the transaction initiator, the digital signature of the transaction recipient, and a format of the transaction request;
the transferring the funds into the account of the transaction recipient from the account of the transaction initiator if the verification of the digital signature of the transaction initiator and the digital signature of the transaction recipient is passed comprises:
transferring the funds into the account of the transaction recipient from the account of the transaction initiator if the verification of the digital signature of the transaction initiator and the digital signature of the transaction recipient, and the format of the transaction request is passed.

6. The method according to claim 1, wherein the method further comprises:
initiating a consensus processing on the transfer of funds;
recording to the blockchain the transfer of funds if the consensus is reached.

7. The method according to claim 1, wherein the transaction request further comprises at least one of a group of a sequence number of the request, a time limit, a security code, a note, and a verification code.

8. The method according to claim 1, wherein the method further comprises:
receiving via a client an input as to content of the transaction;
generating the transaction request according to the transaction content and a format specification of the transaction request, the format specification of the transaction request specifying content which is needed by the transaction record.

9. The method according to claim 1, wherein the verifying the transaction request comprises:
decrypting the transaction request;
verifying the digital signature of the transaction initiator;
verifying that a format of the transaction request meets with a format specification;
verifying that the transaction initiator does have asset ownership of the transaction amount.

10. A system for blockchain transaction comprising:
a transaction initiator terminal configured to generate a transaction request, the transaction request comprising a sign of a transaction initiator, a sign of a transaction recipient, transaction amount, transaction time, and a digital signature of the transaction initiator;
the transaction initiator terminal being further configured to transmit the transaction request to the transaction recipient;
a transaction recipient terminal configured to verify the transaction request;
the transaction recipient terminal being further configured to sign a digital signature of the transaction recipient on the transaction request if the verification is passed;
the transaction initiator terminal being further configured to transfer funds into an account of the transaction recipient from an account of the transaction initiator.

11. The system according to claim 10, wherein:
the transaction recipient terminal is further configured to draw up transaction information in advance before the transaction initiator terminal generating the transaction request, the transaction information comprising the sign of the transaction initiator, the sign of the transaction recipient, the transaction amount, and the transaction time;
the transaction recipient terminal is further configured to transfer the transaction information to the transaction initiator;
the transaction initiator terminal is further configured to generate the transaction request according to the transaction information.

12. The system according to claim 10, wherein:
the transaction recipient terminal is further configured to end the transaction if the verification is failed.

13. The system according to claim 10, wherein the system further comprises a plurality of blockchain nodes:
the transaction recipient terminal is further configured to transmit the transaction request comprising the digital signature of the transaction initiator and the digital signature of the transaction recipient to the blockchain nodes before transferring funds into an account of the transaction recipient from an account of the transaction initiator;
the blockchain nodes are configured to verify the digital signature of the transaction initiator and the digital signature of the transaction recipient;
the transaction initiator terminal is further configured to transfer the funds into the account of the transaction recipient from the account of the transaction initiator if the verification of the digital signature of the transaction initiator and the digital signature of the transaction recipient is passed.

14. The system according to claim 13, wherein:
the blockchain nodes are configured to verify the digital signature of the transaction initiator, the digital signature of the transaction recipient, and the format of the transaction request;
the transaction initiator terminal is further configured to transfer the funds into the account of the transaction recipient from the account of the transaction initiator if the verification of the digital signature of the transaction initiator, the digital signature of the transaction recipient, and the format of the transaction request is passed.

15. The system according to claim 13, wherein:
the blockchain nodes are further configured to initiate a consensus processing on the transfer of funds;
the blockchain nodes are further configured to record to the blockchain the transfer of funds if the consensus is reached.

16. The system according to claim 10, wherein the transaction request further comprises at least one of a group of a sequence number of the request, a time limit, a security code, a note, and a verification code.

17. The system according to claim 10, wherein:
the transaction initiator terminal is further configured to receive via a client an input as to content of the transaction;
the transaction initiator terminal is further configured to generate the transaction request according to the transaction content and a format specification of the transaction request, the format specification of the transaction request specifying content which is needed by the transaction record.

18. The system according to claim 10, wherein the transaction recipient terminal is further configured to:
decrypt the transaction request;
verify the digital signature of the transaction initiator;
verify that a format of the transaction request meets with a format specification;
verify that the transaction initiator does have asset ownership of the transaction amount.
